(19) United States
(12) Patent Application Publication
(10) Pub. No.: US 2007/0103859 A1
(43) Pub. Date: May 10, 2007

(54) Modification of portable computer

(76) Inventor: Jin Shuo Yu, Sindian City (TW)

Correspondence Address: TROXELL LAW OFFICE PLLC;ONE SKYLINE PLACE, SUITE 1404, 5205 LEESBURG PIKE, FALLS CHURCH, VA, 22041, US

(21) Appl. No.: 11/443,034

(22) Filed: May 31, 2006

(30) Foreign Application Priority Data
Nov. 4, 2005 (TW) 095206036

(51) Int. Cl. G06F 1/16

(52) U.S. Cl. 361/683

(57) ABSTRACT

The present invention discloses a modification of portable computer. The bottom of the lower seat of a notebook computer is provided with supporting pieces which can retrieve within and protrude over the bottom and which can render the aforementioned bottom to maintain a slanting angle and a gap with respect to the residing surface.

### FIELD OF THE INVENTION

The present invention relates a modification of portable computer, and particularly to, for example but not limited to, a notebook computer whose bottom provided with supporting pieces which can retrieve within and protrude over the bottom and which can render the aforementioned bottom to maintain a slanting angle and a gap with respect to the residing surface.

### BACKGROUND OF THE INVENTION

Portable computer, notebook computer for example, is very popular in this modern society. Conventional notebook computer is usually with a lifting-up monitor and a lower seat provided with a keyboard and electronic components within the housing.

When we use a notebook computer and put it on, for example but not limited to, a table, the bottom of the notebook computer is placed flat on the table. Users can then lift its upper cover, i.e. monitor, and operate it just like a desktop computer.

This way of using a notebook computer has been practiced for years. Although the basic functions have never been compromised, the use of keyboard in this way does not comply with the requirements of ergonomics since the computer is parallel to the table face. Furthermore, the heat generated during the operation of the computer is difficult to dissipate when the computer bottom is intimately contacted with the table face. Consequently, it is necessary to provide a new design to overcome the drawbacks described above.

### SUMMARY OF THE INVENTION

To meet such a demand, the applicant having a long time experience in designing, production, and marketing of technology products proposes the present invention, a modification of portable computer, as a result of numerous trials and experiments.

To further disclose the technical details of the present invention, please refer to the figures, wherein FIG. 1 is a perspective view of the first embodiment according to the present invention, FIG. 2 is a cross-sectional view of the supporting piece of the first embodiment according to the present invention, FIG. 3 is a perspective view of the second embodiment according to the present invention, FIG. 4 is a perspective view of the third embodiment according to the present invention, and FIG. 5 is a perspective view of the fourth embodiment according to the present invention.

### BRIEF DESCRIPTION OF THE DRAWINGS

The present invention can be more fully understood by reference to the following description and accompanying drawings, in which:

FIG. 1 is a perspective view of the first embodiment of a modification of portable computer according to the present invention;

FIG. 2 is a cross-sectional view of the supporting piece of the first embodiment of a modification of portable computer according to the present invention;

FIG. 3 is a perspective view of the second embodiment of a modification of portable computer according to the present invention;

FIG. 4 is a perspective view of the third embodiment of a modification of portable computer according to the present invention; and

FIG. 5 is a perspective view of the fourth embodiment of a modification of portable computer according to the present invention.

### DETAILED DESCRIPTION OF THE INVENTION

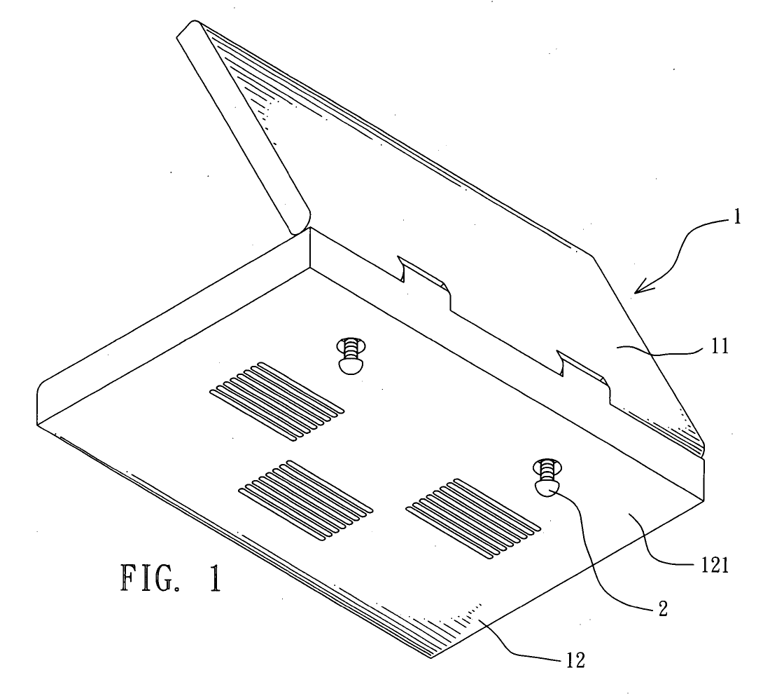

Referring to FIGS. 1 to 5, the modification of portable computer according to the present invention comprises a notebook computer 1 and a supporting piece 2, wherein the notebook computer 1 comprises a upper cover 11 provided with a monitor therein (not shown due to the projection angle) and a lower seat 12 whose upper face is provided with a keyboard or other operational keys (not shown due to the projection angle), which are conventional prior art and will not be discussed furthermore.

The distinct feature of the present invention is the supporting piece 2 provided on the bottom 121 of the lower seat 12. The supporting piece 2, which is connected with the lower seat 12, can retrieve within and protrude over the bottom 121. Consequently, when the supporting piece 2 is pulled out, it can render the bottom 121 of the lower seat 12 to maintain a slanting angle and a gap with respect to the table. Therefore, the operation of the keyboard can comply with the requirements of ergonomics and the bottom 121 is not intimately contacted with the working surface.

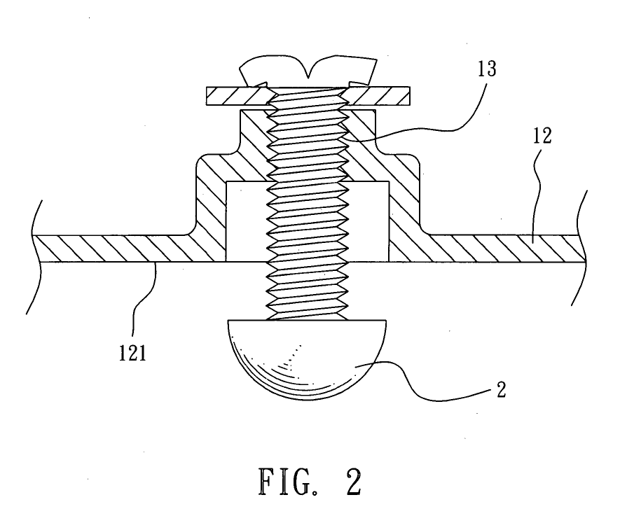

To achieve the functions described above, the first embodiment according to the present invention as shown in FIG. 1 provides a screw device as the supporting piece 2. A screw hole 13 is provided in the notebook computer 1 for height adjustment (FIG. 2). Also, two supporting pieces 2 are provided in the present embodiment to achieve better stability.

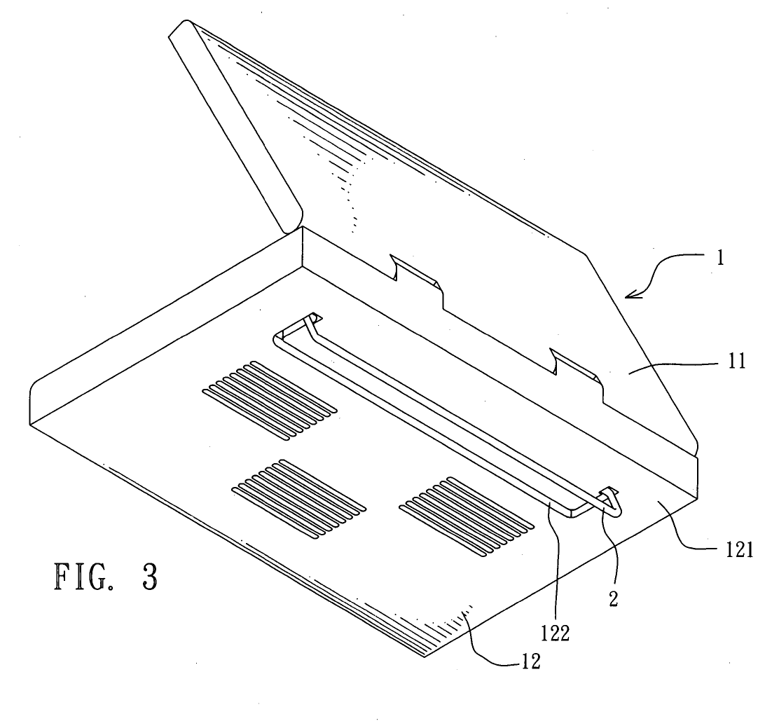

Referring to FIG. 3, the second embodiment according to the present invention provides a U-shape wire as the supporting piece 2. A groove 122 is provided on the bottom 121 of the lower seat 12 to receive the U-shape supporting piece 2. Two ends of the supporting piece 2 are provided with a spring, respectively, to retrieve or protrude the supporting piece 2.

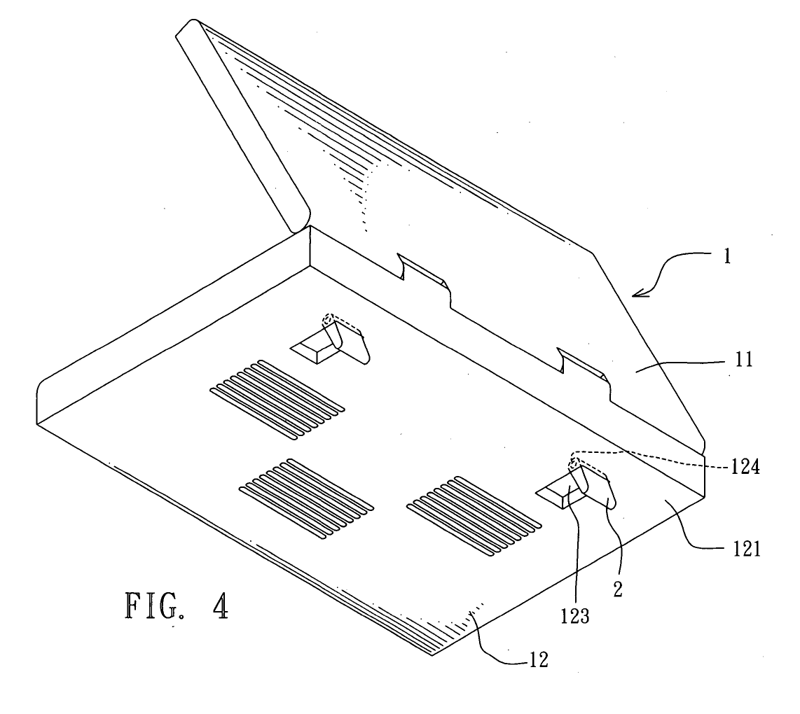

Referring to FIG. 4, the third embodiment according to the present invention provides two flat pieces as the supporting piece 2. A slot 123 is provided on the lower seat 12 to receive the supporting piece 2 and a pivot 124 is provided on both sides of the slot 123, respectively, to pivotally connect with the supporting piece 2. In this way, the supporting piece 2 can also achieve the functions of retrieving within and protruding over the bottom 121. The supporting piece 2 in the present embodiment is two short pieces.

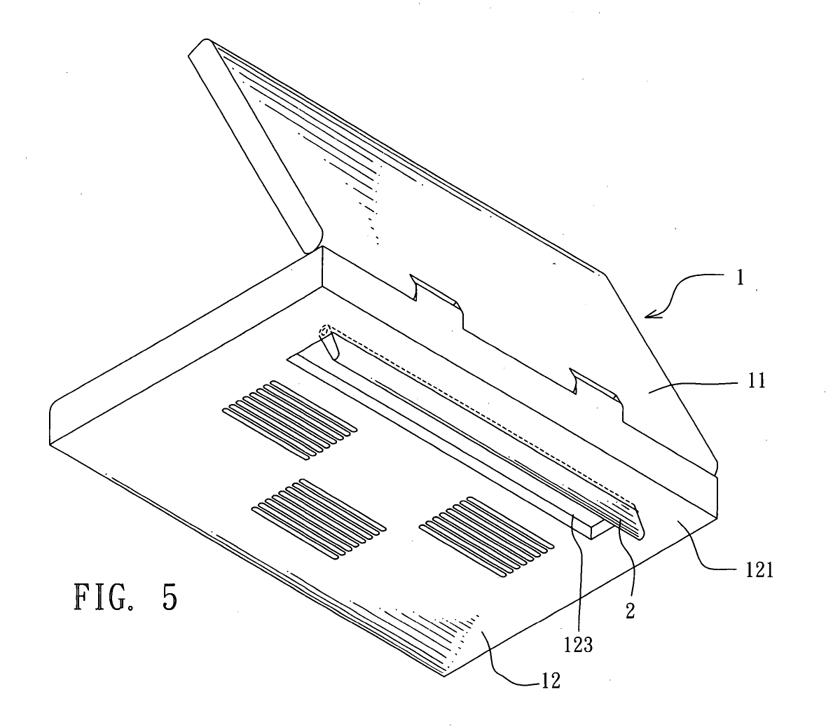

Referring to FIG. 5, the fourth embodiment according to the present invention provides a long, narrow plate as the supporting piece 2 to achieve the functions described above.

Consequently, by lifting the lower seat 12 of the notebook computer 1 with the supporting piece 2, the keyboard can maintain a slanting angle and a gap with respect to the working surface. Thus, the design complies with the requirements of ergonomics and help to dissipate the heat generated during the operation of the computer.

While the invention has been described with reference to the a preferred embodiment thereof, it is to be understood that modifications or variations may be easily made without departing from the spirit of this invention, which is defined by the appended claims.

What is claimed is:

1. A modification of portable computer, wherein the bottom of the lower seat of a notebook computer is provided with supporting pieces which can retrieve within and protrude over the bottom and which can render the aforementioned bottom to maintain a slanting angle and a gap with respect to the residing surface.

2. The modification of portable computer according to claim 1, wherein the supporting piece is two separate screws and the bottom of the notebook computer is provided with a screw hole for each screw to engage with and to ascend or descend.

3. The modification of portable computer according to claim 1, wherein the supporting piece is a U-shape wire which is received in a groove provided on the bottom of the notebook computer and two ends of the supporting piece are pivotally connected the bottom.

4. The modification of portable computer according to claim 1, wherein the supporting piece is two flat pieces pivotally connected to separate slots provided on the bottom of the notebook computer.

5. The modification of portable computer according to claim 1, wherein the supporting piece is a long, narrow plate pivotally connected to a groove provided on the bottom of the notebook computer.
